(19) United States
(12) Patent Application Publication
(10) Pub. No.: US 2023/0402746 A1
(43) Pub. Date: Dec. 14, 2023

(54) RADOME CAPABLE OF MODIFYING ANTENNA RADIATION PATTERN

(71) Applicant: Alpha Networks Inc., Hsinchu (TW)

(72) Inventors: YAO-JEN CHEN, Hsinchu (TW); CHIA-HSIEN CHEN, Hsinchu (TW)

(21) Appl. No.: 18/120,724

(22) Filed: Mar. 13, 2023

(30) Foreign Application Priority Data
Jun. 9, 2022 (TW) 111121407

(51) Int. Cl. H01Q 1/42

(52) U.S. Cl. CPC H01Q 1/42

(57) ABSTRACT

A radome is provided for covering an antenna. The radome is disposed in a transmission path of a radiation from the antenna and modifies a radiation pattern of the antenna when the radiation from the antenna penetrates therethrough. The radome has a first surface and a second surface opposite to the first surface and facing the antenna, and includes a plurality of through holes penetrating through the first and second surfaces and having first and second openings on the first and second surfaces, respectively. The first openings of the through holes are allocated in at least a central area of the first surface, an inner annular area of the first surface surrounding the central area, and/or an outer annular area of the first surface surrounding the inner annular area in a manner that an area-averaged permittivity is increasing radially outwards from the central area toward the outer annular area.

### FIELD OF THE INVENTION

The present invention relates to a radome, and more particularly to a radome, through which a radiation pattern of an antenna can be modified.

### BACKGROUND OF THE INVENTION

For safe driving, it is common to install radar antennas on a vehicle to detect obstacles. Conventionally, microstrip antennas are used as the radar antennas. Since the microstrip antennas have limited horizontal and vertical radiation angles, it is necessary to install a number of microstrip antennas at several locations in order to monitor a relatively large area. Therefore, in addition to hardware costs, it is also critical to properly allocate the multiple antennas. The overall design of the vehicle would become complicated.

### SUMMARY OF THE INVENTION

For solving the above-mentioned problems, the present invention provides a radome, through which a radiation pattern of an antenna can be modified so as to enlarge radiation angles.

The present invention provides a radome

According to the present invention, a radome is provided for covering an antenna. The radome is disposed in a transmission path of a radiation from the antenna and modifies a radiation pattern of the antenna when the radiation from the antenna penetrates therethrough. The radome has a first surface and a second surface opposite to the first surface and facing the antenna, and comprises a plurality of through holes penetrating through the first and second surfaces and having first and second openings on the first and second surfaces, respectively. The first openings of the through holes are allocated in at least a central area of the first surface, an inner annular area of the first surface surrounding the central area, and/or an outer annular area of the first surface surrounding the inner annular area in a manner that an area-averaged permittivity is increasing radially outwards from the central area toward the outer annular area.

### BRIEF DESCRIPTION OF THE DRAWINGS

The invention will become more readily apparent to those ordinarily skilled in the art after reviewing the following detailed description and accompanying drawings, in which:

FIG. 1 is a block diagram schematically illustrating a use of a radome according to an embodiment of the present invention for protecting an antenna and modifying a radiation pattern of the antenna;

FIG. 2 is a schematic diagram illustrating a top view of a radome according to an embodiment of the present invention; and

FIG. 3 is a schematic diagram illustrating a top view of a radome according to another embodiment of the present invention.

### DETAILED DESCRIPTION OF PREFERRED EMBODIMENTS

The invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

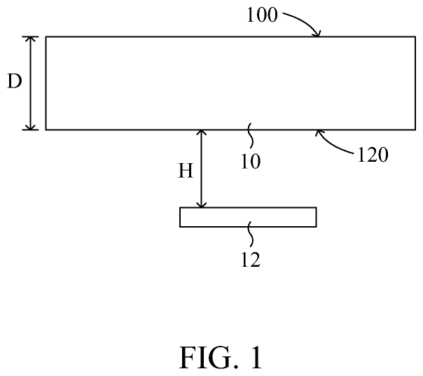

Please refer to FIG. 1, in which a radome according to an embodiment of the present invention is schematically illustrated. In this embodiment, the radome 10 is made of a single material having a proper permittivity. For example, the radome 10 can be made of Polybutylene Terephthalate (PBT). The radome 10 is used for covering and protecting a radar antenna 12 and disposed in a path of a majority of electromagnetic radiation from the antenna 12. In other words, the electromagnetic radiation from the antenna 12 will penetrate through the radome 10, and meanwhile, a radiation pattern of the antenna 12 will be modified by the radome 10. The radome 10 has a surface 100 and a surface 120 opposite to the surface 100, as shown in FIG. 1, and a distance between the surface 100 and the surface 120 is defined as a thickness D of the radome 10. The surface 120 of the radome 10 faces the antenna 12 and has a clearance H from the closest surface of the antenna 12.

Desirably but not necessarily, the center of the second surface 120 of the radome 10 is aligned with the center of the antenna 12 as shown. Those skilled in the art could adjust the position, orientation and/or other parameters of the radome 10 relative to the antenna 12 depending on practical requirements. Furthermore, in order to minimize power loss of the electromagnetic radiation when it travels from the antenna 12 into the radome 10, i.e., insertion loss, it is desirable but not necessarily to set the clearance H between the radome 10 and the antenna 12 to be an integer multiple of half a wavelength of the electromagnetic radiation in the transmission medium between the radome 10 and the antenna 12. For example, when the frequency of the electromagnetic radiation from the antenna 12 is about 14.5 GHz and the transmission medium between the radome 10 and the antenna 12 is air, the wavelength of the electromagnetic radiation is about 21 mm. Therefore, it is preferrable that the clearance H between the radome 10 and the antenna 12 is set to be 10.5 mm or an integer multiple of 10.5 mm to minimize insertion loss. Likewise, for the same purporse, the thickness D can also be set to be an integer multiple of half a wavelength of the electromagnetic radiation traveling from the surface 120 toward the surface 100 in the material of radome 10. For example, when the wavelength of the electromagnetic radiation traveling in the radome 10 is about 12.12 mm, it is preferrable that the thickness D of the radome 10 is set to be 6.06 mm or an integer multiple of 6.06 mm to minimize insertion loss of the electromagnetic radiation from the radome 10 into the air off the first surface 100.

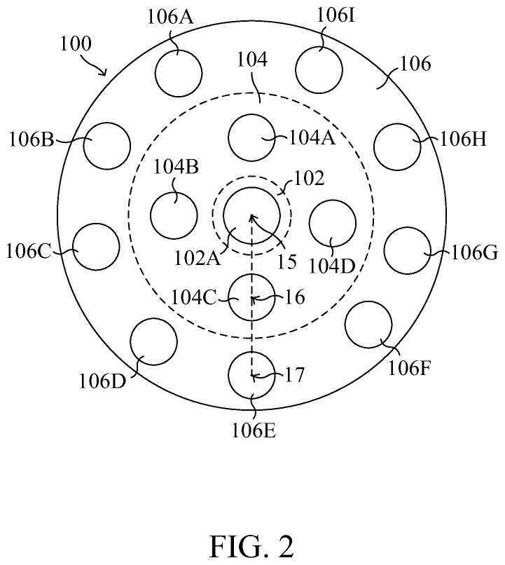

Subsequently, please refer to FIG. 2, which schematically illustrates an exemplary configuration of the radome 10 viewed from above the surface 100. In this example, a plurality of holes 102A, 104A-104D and 106A-1061 are formed in and penetrate through the radome 10. These through holes are desirably but not necessarily symmetrically allocated and evenly spaced as shown in FIG. 2. The holes 102A is located in a central circular area 102 of the surface 100, the holes 104A-104D are located in an inner annular area 104 of the surface 100 surrounding the central circular area 102, and the holes 106A-1061 are located in an outer annular area 106 of the surface 100 surrounding the inner annular area 104. Desirably but not necessarily, each of the through holes is shaped as an upright hollow cylinder, whose openings on the surface 100 and the surface 120 are substantially identical in shape and size. In other words, the through holes 102A, 104A-104D and 106A-1061 are allocated on the surface 102 in a manner similar to the allocation on the surface 100. It is understood that the above examples are given for illustration only, and those skilled in the art may modify the configurations and positions of the through holes depending on practical requirements. For example, the central area and annular areas may be defined as a rectangular shape or any other suitable geometric shape instead of being circular. Moreover,

Following the above-described exemplary case that the wavelength of the electromagnetic radiation traveling in the radome 10 is about 12.12 mm, it is preferable to set the radius of the opening of the through hole 102A on the surface 100 to be slightly less than 6.06 mm, which is half the wavelength of the electromagnetic radiation traveling in the radome 10. Meanwhile, it is preferable to set the diameter of the opening of each of the through holes 104A-104D and 106A-1061 on the surface 100 to be slightly less than 6.06 mm. In addition, the center of the opening of the through hole 102A on the surface 100 is located at the center 15 of the surface 100. Respective centers of the openings of the through holes 104A-104D on the surface 100 are located at corresponding radially middle points 16 of the inner annular area 104. Each of the radially middle points 16 of the inner annular area 104 is defined as a point having equal radial distances from the inner circumference and the outer circumference of the annular area 104. Likewise, respective centers of the openings of the through holes 106A-1061 on the surface 100 are located at corresponding radially middle points 17 of the outer annular area 106. Each of the radially middle points 17 of the outer annular area 106 is defined as a point having equal radial distances from the inner circumference and the outer circumference of the annular area 106. Furthermore, a distance between two radially adjacent through holes, e.g., the though hole 104C in the inner annular area 104 and the through hole 106E in the outer annular area 106, which can be measured as the distance between the radially middle point 16 and the radially middle point 17, is preferably slightly less than 6.06 mm, i.e., half the wavelength of the electromagnetic radiation traveling in the radome 10.

It is understood that the number and sizes of the annular area defined on the surface of the radome, as well as the number and positions of the through holes created in each of the annular area, are not limited to those shown in FIG. 2, and can be designed or modified based on practical requirements. However, it is desirable that the through holes are allocated to have the averaged permittivity increasing radially outwards, i.e., from the central circular area toward the outer annular area. In other words, the averaged permittivity of the outer annular area 106 should be greater than that of the inner annular area 104, and the averaged permittivity of the inner annular area 104 should be greater than that of the central circular area 102.

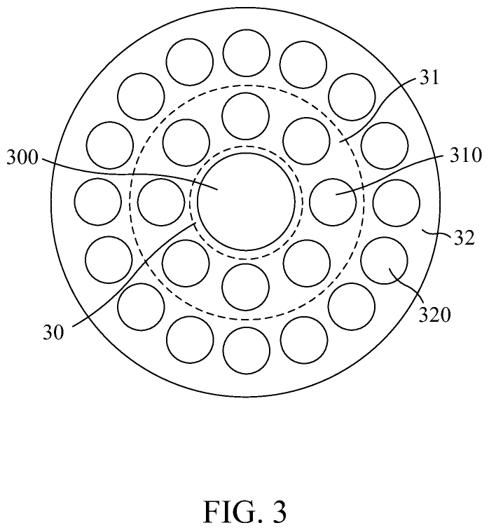

Another exemplary configuration of the radome 10 is schematically shown in FIG. 3, which is viewed from above the surface 100. In this example, the radome is made of a material having a permittivity of 3*8.85×10⁻¹², and has a thickness of 6.06 mm and a diameter of 40 mm. In this example, a plurality of holes 300, 310 and 320 are formed in and penetrating through the radome. These through holes in this example are desirably but not necessarily symmetrically allocated as shown in FIG. 3, wherein one hole 300 is located in a central circular area 30 and has a radius of 5.7 mm; eight holes 310 are located in an inner annular area 31 surrounding the central circular area 30 and each of them has a radius of 2.75 mm; and sixteen holes 320 are located in an outer annular area 32 surrounding the inner annular area 31 and each of them has a radius of 2.75 mm. Experimental results show that by centrally locating the radome provided according to the present invention above an antenna, which radiates an electromagnetic wave having a frequency of 14.5 GHz, the horizontal radiation angle of the electromagnetic radiation from the antenna and penetrating through the radome is enlarged from 72 degrees to 98 degrees, and the vertical radiation angle is enlarged from 75 degrees to 100 degrees. In other words, when the electromagnetic radiation of the antenna penetrates through the radome according to the present invention, the radiation pattern can be modified through the radome, and thus the horizontal and vertical radiation angles can be significantly enlarged to a level of, for example, more than 130% of the conventional ones.

Like the example of radome illustrated in FIG. 2, the number, coverages and/or sizes of the annular area defined on the surface of the radome, as well as the number, shapes, sizes and/or positions of the through holes in each of the annular area, are not limited to those shown in FIG. 3, and can be designed and modified based on practical requirements.

To sum up, the present invention provides a radome, which is specifically configured to modify a pattern of an electromagnetic radiation from an antenna covered thereby and penetrating therethrough. With the modified radiation pattern, horizontal and vertical radiation angles of the antenna are enlarged. The configuration of the radome can be adjusted by creating different numbers, shapes, sizes and/or positions of through holes therein. In particular, the radome is configured to have increasing permittivity along a radially outward direction. Since the radiation angles of the antenna are enlarged according to the present invention, the antenna can be used to monitor a relatively large range pf area, so the overall number of antennas required can be reduced.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A radome for covering an antenna, being disposed in a transmission path of a radiation from the antenna and modifying a radiation pattern of the antenna when the radiation from the antenna penetrates therethrough, wherein:
the radome has a first surface and a second surface opposite to the first surface and facing the antenna, and comprises a plurality of through holes penetrating through the first and second surfaces and having first and second openings on the first and second surfaces, respectively, and
the first openings of the through holes are allocated in at least a central area of the first surface, an inner annular area of the first surface surrounding the central area, and/or an outer annular area of the first surface surrounding the inner annular area in a manner that an area-averaged permittivity is increasing radially outwards from the central area toward the outer annular area.

2. The radome according to claim 1, wherein a clearance between the radome and the antenna is about an integer multiple of half a wavelength of the radiation in a transmission medium between the radome and the antenna.

3. The radome according to claim 1, wherein a thickness of the radome is about an integer multiple of half a wavelength of the radiation travelling from the second surface toward the first surface in a material of the radome.

4. The radome according to claim 1, wherein a distance between respective centers of two of the first openings, which are disposed in the inner annular area and the outer annular area, respectively, and radially adjacent to each other, is slightly less than half a wavelength of the radiation travelling from the second surface toward the first surface in a material of the radome.

5. The radome according to claim 1, wherein one of the first openings in the inner annular or outer annular area has a diameter slightly less than half a wavelength of the radiation travelling from the second surface toward the first surface in the material of the radome.

6. The radome according to claim 1, wherein one of the first openings in the central area has a radius slightly less than half a wavelength of the radiation travelling from the second surface toward the first surface in a material of the radome.

7. The radome according to claim 6, wherein a center of the one of the first openings in the central area is located at a center of the first surface.

8. The radome according to claim 1, wherein the first openings in each of the inner and outer annular area are evenly spaced.
